(19) United States
(12) Patent Application Publication
(10) Pub. No.: US 2021/0164177 A1
(43) Pub. Date: Jun. 3, 2021

(54) ANTI-COLLISION WILDLIFE ROAD SIGN SYSTEM

(71) Applicant: Zachary Allyn Wientjes, Jackson, WY (US)

(72) Inventor: Zachary Allyn Wientjes, Jackson, WY (US)

(21) Appl. No.: 16/599,311

(22) Filed: Oct. 11, 2019

(51) Int. Cl. E01F 9/615; G08B 5/36; G08G 1/16; G09F 7/18; G09F 13/18

(52) U.S. Cl. CPC E01F 9/615; G08B 5/36; G08G 1/16; G09F 2013/1863; G09F 13/18; G09F 2007/1804; G09F 2007/1873; G09F 7/18

(57) ABSTRACT

An anti-collision wildlife road sign is disclosed, comprising a road sign having a housing shaped in the form of a hazard. The road sign is positioned in an environment wherein the hazard is likely. A reflective element is provided on a surface of the housing to reflect light emitted by a motor vehicle to facilitate alerting a motor vehicle operator of the presence of the hazard in the environment.

### TECHNICAL FIELD

The embodiments generally relate to traffic and road signage which alert drivers of potential wildlife hazards.

### BACKGROUND

Traffic signs or road signs are signs provided at the side of or above roads to give instructions or provide information to travelers. Many signs are affixed to structures along the roadway or are affixed to wooden or metal posts to display the sign to the traveler.

Many categories of road signs exist including for example, danger warning signs, priority signs, prohibitory or restrictive signs, mandatory signs, special regulation signs, information signs, facility signs, service signs, direction signs, positions signs, and indication signs.

In the current arts, signs are constructed based on standardized ruling for the particular municipality, country, or region in which they are erected. Often, the shape, information, and design of the sign is dictated by the category of the sign itself. However, in high-risk areas, unconventional signage may be utilized to raise awareness of the driver to a potential risk on the roadway.

Many road signs are not visible in low light conditions, especially when there are no streetlights along the road. This is especially prevalent in rural areas where wildlife presence on or near the road is common. Many signs are only visible when illuminated by the headlights of a vehicle, which may go unnoticed by the vehicle operator.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to an anti-collision wildlife road sign comprising a road sign having a housing shaped in the form of a hazard. The road sign is positioned in an environment wherein the hazard is likely. A reflective element is provided on a surface of the housing to reflect light emitted by a motor vehicle to facilitate alerting a motor vehicle operator of the presence of the hazard in the environment.

The road sign may be positioned in any environment and is configured to be moveable to various locations to accommodate wildlife hazards and changing migration patterns. The system provides a more efficient means for alerting vehicle operators of nearby wildlife hazards compared to road signs currently available.

The road sign may include a hollow housing to contain at least some components of a wildlife hazard detection and alert system to aid in the detection of nearby wildlife and facilitate the efficient alert of nearby vehicle operators and/or pedestrians.

In one aspect, the reflective element is a reflective tape adhered to the surface of the housing.

In one aspect, the hazard is a wildlife animal, and wherein the housing is shaped in the configuration of the wildlife animal.

In one aspect, the road sign further comprises a plurality of support members to anchor the road sign to a ground surface. The support members extend to one or more bases which may articulate to suitably interface with the ground surface.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a front elevation view of the road sign and hazard alert system, according to some embodiments;

FIG. 2 illustrates a front elevation view of the road sign and hazard alert system, according to some embodiments;

FIG. 3 illustrates a perspective view of the road sign deployed near a road, according to some embodiments; and

FIG. 4 illustrates a block diagram of the wildlife detection and alert system in operable communication with the road sign, according to some embodiments.

### DETAILED DESCRIPTION

The specific details of the single embodiment or variety of embodiments described herein are to the described device and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components of the device and its use. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a road sign system including a sign constructed in the shape of a hazard (such as an animal, wildlife, or other hazardous element) which has the potential to cause a dangerous environment to vehicle operators on a roadway. The embodiments may be particularly useful in low light conditions which may include no-light conditions to alert travelers of inherent risks in the region in which the road sign system is deployed. The road sign system may be stationary or mobile to allow an operator to move the road sign as required by hazard movement.

As used herein, the terms “road”, “roadway”, and similar terms known to those skilled in the arts refers to a passage used by vehicle operators or other forms of travelers.

As used herein, the term “hazard” can include any roadway hazard including those commonly illustrated on signs as well as new hazards. In particular, the road sign system may be particularly useful for alerting drivers of wildlife or other animal hazards commonly encountered in a region such as deer, elk, cattle, bears, ducks, and other wildlife.

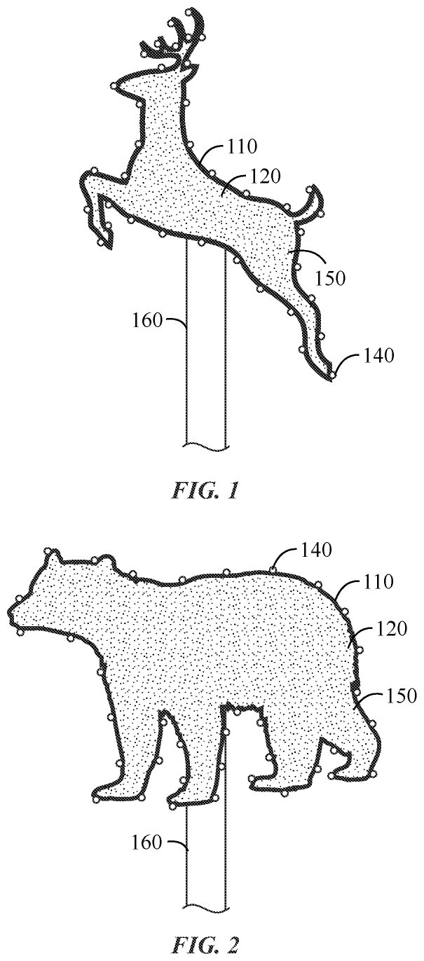

In reference to FIG. 1 and FIG. 2, the road sign 110 is illustrated in various exemplary embodiments. The housing 120 of the road sign 110 is constructed to resemble an animal, such as animals found in the wildlife population in the region the road sign 110 is deployed. The road sign comprises an alert system which may include a plurality of lights 140 positioned on the surface of the road sign 110. A reflective element 150 may be applied to the exterior surface of the road sign 110 to reflect light emitted from various sources in the environment of the road sign (such as light from the sun, street lights, vehicles, or lights positioned to illuminate the sign), to alert nearby persons of the presence of the sign and the potential for hazards.

In further reference to FIG. 1 and FIG. 2, the road sign 110 housing 120 is comprised of a hollowed interior to provide a 3-dimensional shape to the road sign 110 to aid in alerting drivers from various vantage points about the road sign 110. In such, the road sign aids in providing a means for warning vehicle operators and pedestrians of a potential hazard (such as a hazard presented by dangerous wildlife in the environment wherein the road sign is disposed). The housing 120 is retained in an upright position by a plurality of support members 160 dimensioned to erect the road sign 110 at a sufficient height to alert nearby vehicle operators and/or pedestrians.

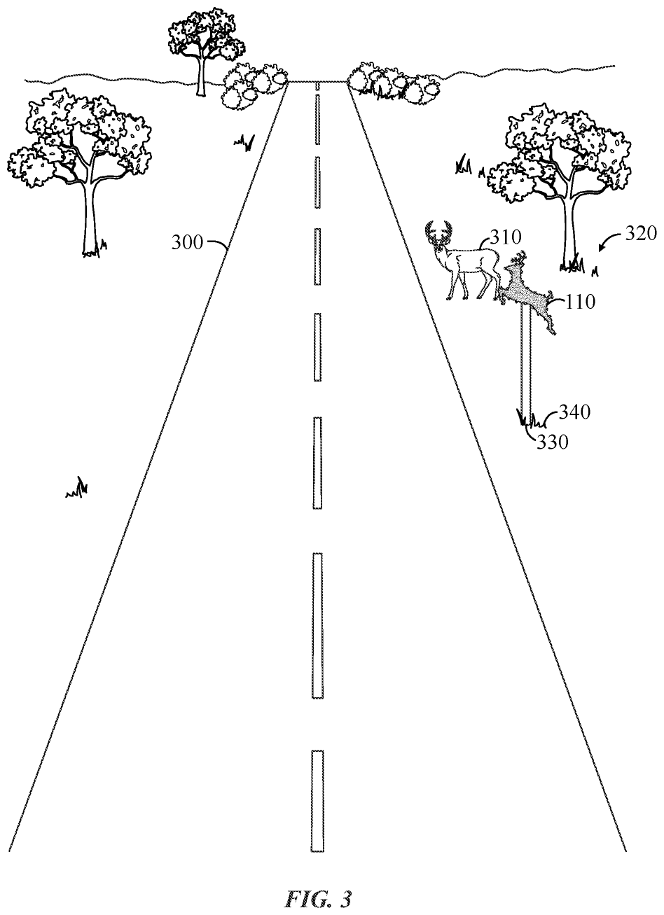

FIG. 3, illustrates a roadway 300 having the road sign 110 positioned near the road to alert vehicle operators of a hazard 310 (shown as a deer). The lights on the road sign aid in alerting nearby vehicle operators and/or pedestrians of the potential hazards in the surrounding environment 320. Each support member 160 includes a base 330 which provides a means for anchoring the road sign 110 to the ground surface 340. The base 330 may articulate to form a coplanar mounting surface with respect to the ground surface 340 to provide a sufficiently strong connection to support the road sign in inclement weather or during impact.

The road sign is configured to be repeatedly moveable to various locations as necessary. This may be especially useful for animal populations which travel large distances throughout the year.

In some embodiments, the base comprises a plurality of platforms, for example, three platforms which may each articulate independently. In an alternate embodiment, the base may be a plurality of stakes positioned through the “feet” of the housing wherein the housing is configured in the shape of wildlife. For example, in an embodiment wherein the housing is configured as a deer, the stakes may protrude through the hoofs of the deer and into the ground surface.

In some embodiments, the base is removably engaged with the support members to allow for various mounting options when securing the road sign to the ground surface. One skilled in the arts will readily understand that various base configurations and sizes may be utilized in various ground surface conditions.

In some embodiments, the housing, support elements, and other structural and non-structural components of the road sign may be constructed of various materials including, but not limited to plastics, polymers, plexiglass, and aluminum. The exterior surfaces of the road sign may be constructed of various materials which may aid in the structural integrity of the road sign, or to the visibility of the road sign such as through the use of fabrics, reflective fabrics, reflective paint, reflective film, glass cloth, or similar materials known in the arts. In some embodiments, the structural elements of the road sign system are constructed to withstand potential damage from hazardous environmental conditions such as high winds, rain, and snow.

In some embodiments, the reflective element includes a photoluminescent composition such as high intensity prismatic (HIP) reflective film which is approved by the United Stated Department of Transportation. One skilled in the arts will readily understand that various reflective compositions and components may be utilized to provide a reflective surface to the surface of the road sign. One skilled in the arts will readily understand that various reflective elements may be utilized to aid in alerting vehicle operators and/or pedestrians of a potential hazard.

In some embodiments, the road sign system may include a power source to store power for the road sign lights, and other electrical components. The road sign system may also include a power receiving means such as a photo cell positioned to receive sunlight and convert sunlight to power used to operate the electrical components of the road sign system.

In some embodiments, the road sign system may include text, such as standard text to depict wording used in roadway warning signs such as “Wildlife Crossing” or animal specific crossing signs.

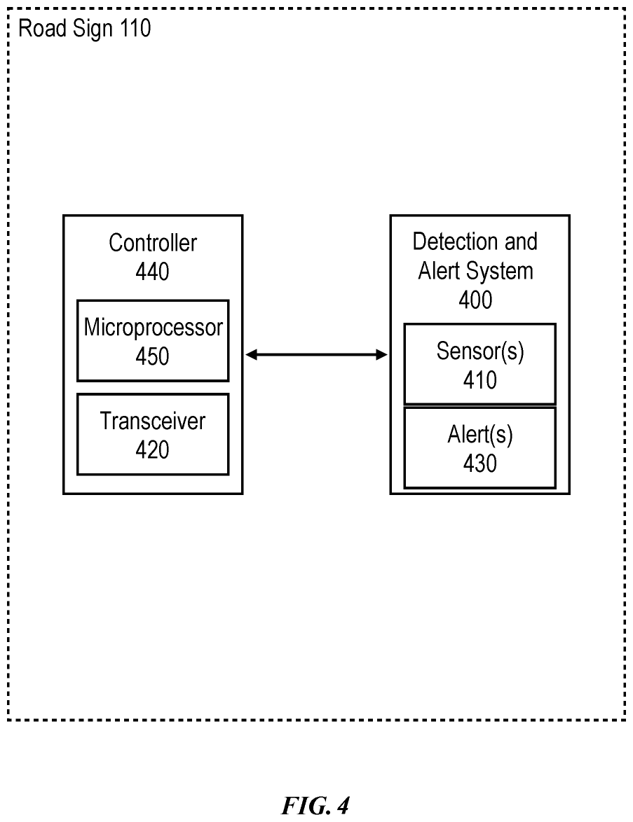

In reference to FIG. 4, the road sign may also include a wildlife detection and alert system 400 to monitor wildlife in the environment surrounding the road sign 110 and alert vehicle operators and/or nearby pedestrians of the presence of wildlife. The detection and alert system 400 is comprised of a plurality of sensors 410 arranged to detect wildlife or other hazards in the environment surrounding the road sign 110. The sensors 410 may include motion detectors, vehicle detectors, proximity detectors, and the like to sense the presence of wildlife, vehicles, pedestrians, and other hazards in the environment. Each sensor 410 transmits an alert signal to the wildlife detection and alert system 400 to transmit an alert 430. A controller 440 is in operable communication via a transceiver 420 with the detection and alert system 400 and provides an input means for user-selectable settings, such as alert output and detection sensitivity. A microprocessor 450 is operable to perform instructions received from the controller 440.

In some embodiments, the wildlife detection and alert system may be powered by a solar cell, battery, or other energy transmission or energy storage system known in the arts.

Program modules can include routines, programs, components, data structures and the like, which perform particular tasks or implement particular data types. Moreover, the methods can be practiced with other computer system configurations, including single-processor or multiprocessor computer systems, mini-computers, server-scale computers, as well as small computers, hand-held or mobile computing devices, microprocessor-based or programmable consumer electronics such as mobile phones, tablets, vehicle detectors, proximity detectors, motion detectors, and the like, each of which can be operatively coupled to one or more associated devices.

The described technology may also be practiced in distributed computing environments where certain tasks are performed by remote processing devices that are linked through a communications network. In a distributed computing environment, program modules can be located in both local and remote memory storage devices.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An anti-collision wildlife road sign, comprising:
a road sign comprising a housing shaped in the form of a hazard, the road sign positioned in an environment wherein the hazard is likely; and
a reflective element provided on a surface of the housing to reflect light emitted by a motor vehicle to facilitate alerting a motor vehicle operator of the presence of the hazard in the environment.

2. The anti-collision wildlife road sign of claim 1, wherein the reflective element is a reflective tape adhered to the surface of the housing.

3. The anti-collision wildlife road sign of claim 1, wherein the hazard is a wildlife animal, and wherein the housing is shaped in the configuration of the wildlife animal.

4. The anti-collision wildlife road sign of claim 1, further comprising a plurality of bases to anchor the road sign to a ground surface.

5. The anti-collision wildlife road sign of claim 4, further comprising a plurality of support members extending between the plurality of bases and the road sign.

6. The anti-collision wildlife road sign of claim 5, further comprising one or more stakes positioned through the road sign to anchor the road sign to the ground surface.

7. An anti-collision wildlife road sign, comprising:
a road sign comprising a housing shaped in the form of a hazard, the road sign positioned in an environment wherein the hazard is likely;
a reflective element provided on a surface of the housing to reflect light emitted by a motor vehicle to facilitate alerting a motor vehicle operator of the presence of the hazard in the environment; and
a detection and alert system configured to detect wildlife via a plurality of sensors and convey an alert.

8. The anti-collision wildlife road sign of claim 7, wherein the reflective element is a reflective tape adhered to the surface of the housing.

9. The anti-collision wildlife road sign of claim 7, wherein the hazard is a wildlife animal, and wherein the housing is shaped in the configuration of the wildlife animal.

10. The anti-collision wildlife road sign of claim 7, further comprising a plurality of bases to anchor the road sign to a ground surface.

11. The anti-collision wildlife road sign of claim 10, further comprising a plurality of support members extending between the plurality of bases and the road sign.

12. The anti-collision wildlife road sign of claim 11, further comprising one or more stakes positioned through the road sign to anchor the road sign to the ground surface.

13. The anti-collision wildlife road sign of claim 7, wherein the alert is a light positioned on the housing.

14. The anti-collision wildlife road sign of claim 7, wherein the plurality of sensors includes at least one of the following: a vehicle detector, a proximity detector, and a motion detector.

15. An anti-collision wildlife road sign, comprising:
a road sign comprising a housing shaped in the form of a hazard, the road sign positioned in an environment wherein the hazard is likely;
a reflective tape provided on a surface of the housing to reflect light emitted by a motor vehicle to facilitate alerting a motor vehicle operator of the presence of the hazard in the environment; and
a detection and alert system configured to detect wildlife via a plurality of sensors and convey an alert via one or more lights provided on the surface of the housing.

16. The anti-collision wildlife road sign of claim 15, wherein the hazard is a wildlife animal, and wherein the housing is shaped in the configuration of the wildlife animal.

17. The anti-collision wildlife road sign of claim 15, further comprising a plurality of bases to anchor the road sign to a ground surface.

18. The anti-collision wildlife road sign of claim 17, further comprising a plurality of support members extending between the plurality of bases and the road sign.

19. The anti-collision wildlife road sign of claim 15, wherein the plurality of sensors includes at least one of the following: a vehicle detector, a proximity detector, and a motion detector.

20. The anti-collision wildlife road sign of claim 19, wherein the housing provides an enclosure for a controller in operable communication with the detection and alert system.
